(19) United States
(12) Patent Application Publication
(10) Pub. No.: US 2013/0254277 A1
(43) Pub. Date: Sep. 26, 2013

(54) Methods And Networks For Device To Device Communication

(71) Applicants: Subramanian Vasudevan, Morristown, NJ (US); Ioannis Broustis, Millburn, NJ (US); Violeta Cakulev, Millburn, NJ (US); Semyon Mizikovsky, Morganville, NJ (US); Ganesh Sundaram, Hillsborough, NJ (US)

(72) Inventors: Subramanian Vasudevan, Morristown, NJ (US); Ioannis Broustis, Millburn, NJ (US); Violeta Cakulev, Millburn, NJ (US); Semyon Mizikovsky, Morganville, NJ (US); Ganesh Sundaram, Hillsborough, NJ (US)

(73) Assignee: ALCATEL-LUCENT USA INC., Murray Hill, NJ (US)

(21) Appl. No.: 13/425,957

(22) Filed: Mar. 21, 2012

(51) Int. Cl. H04W 4/12; G06F 15/16

(52) U.S. Cl. 709/204

(57) ABSTRACT

At least one example embodiment discloses a method of controlling communications between first and second user equipments (UEs) by a base station in a network. The method includes obtaining an indication, the indication indicating if the first and second UEs are within a communication range of each other and controlling a direct communication link between the first and second UEs if the first and second UEs are within a communication range of each other. The controlling includes allocating at least a first portion of an uplink channel of the network to the direct communication link.

### BACKGROUND

In peer to peer communications, user equipments (UEs) communicate with each other. Conventional UEs are equipped to transmit on the uplink and receive on the downlink, while base stations receive on the uplink and transmit on the downlink. Peer to peer communication may be used for at least public safety and social networking.

To improve public safety, peer to peer communication is used where the cellular infrastructure is unavailable. Peer to peer communication allows user equipments (UEs) to communicate with each other directly in emergency situations.

Peer to peer communication is also used in social networking. More specifically, peer to peer communication allows proximate UEs have to share information.

### SUMMARY

Example embodiments are directed to methods and networks for peer to peer communication. The methods and networks permit an operator of the network to control peer to peer communications.

In one example embodiment, user equipments (UEs) are augmented with a base station receive function. In other words, the UEs are configured to receive data on an uplink transmission channel.

In addition to conventional transmission from the base station to the UEs on the downlink and transmission by UEs on the uplink to the base station, a direct communication link between UEs is supported on the uplink spectrum. The duplexing method used to enable both transmission and reception by UEs on the uplink channel can be implanted in the time domain, frequency domain or code domain, or any combination thereof. Concurrent transmission and reception by the UEs on the same frequency and at the same time is enabled by adding an interference cancellation capability at the UEs. In the absence of such cancellation capability, the transmissions of the UE are separated from the receptions to the UE using any combination of time, frequency or code separation.

A control path for the direct communication link is a pair of bi-directional links between a base station and each of the UEs in the direct-communication pair.

At least one example embodiment discloses a method of controlling communications between first and second user equipments (UEs) by a base station in a network. The method includes obtaining an indication, the indication indicating if the first and second UEs are within a communication range of each other and controlling a direct communication link between the first and second UEs if the first and second UEs are within a communication range of each other. The controlling includes allocating at least a first portion of an uplink channel of the network to the direct communication link.

In one example embodiment, the controlling a direct communication link includes transmitting control information over a control path.

In one example embodiment, the control path includes a bi-directional link between the base station and the first UE and a bi-directional link between the base station and the second UE.

In one example embodiment, the controlling a direct communication link includes transmitting transmission parameters for the direct communication link to the first and second UEs.

In one example embodiment, the transmitting transmission parameters includes transmitting a same set of transmission parameters assigned for the first and second UEs for the direct communication link to the first and second UEs.

In one example embodiment, the transmission parameters are based on the UE.

In one example embodiment, the transmission parameters include a duplex mode, the duplex mode being a full-duplex or a half-duplex.

In one example embodiment, the controlling a direct communication link includes transmitting reception parameters for the direct communication link to the first and second UEs.

In one example embodiment, the method further includes receiving data from the first UE and transmitting the data to the second UE. The second UE is configured to only receive data on a downlink.

In one example embodiment, the method further includes transmitting information on a downlink to the first UE while the first UE monitors communications on the direct communication link.

In one example embodiment, the controlling a direct communication link includes transmitting reception parameters for the direct communication link to the first and second UEs.

At least one example embodiment discloses a first user equipment (UE) configured to receive data from a peer UE over an uplink channel of a network.

In one example embodiment, the first UE is configured to receive control information for reception over a bi-directional link between the first UE and a base station.

In one example embodiment, the first UE is configured to listen in designated slots of an uplink of the network.

In one example embodiment, the first UE is configured to receive transmission parameters from a base station and is configured to determine reception parameters for the uplink channel based on the transmission parameters.

In one example embodiment, the first UE is configured to directly communicate with the peer UE in a half-duplex mode.

In one example embodiment, the first UE is configured to directly communicate with the peer UE in a full-duplex mode.

At least one example embodiment discloses a base station configured to determine if first and second equipments (UEs) are within a communication range of each other, control a direct communication link between the first and second UEs if the first and second UEs are within a communication range of each other and allocate at least a first portion of an uplink channel of a network to the direct communication link.

In one example embodiment, the base station is further configured to transmit transmission parameters for the direct communication link to the first and second UEs.

In one example embodiment, the base station is further configured to transmit a same set of transmission parameters assigned for the first and second UEs for the direct communication link to the first and second UEs.

In one example embodiment, the base station is further configured to transmit reception parameters for the uplink channel of the direct communication link to the first and second UEs.

In one example embodiment, the base station is further configured to transmit reception parameters for the uplink channel of the direct communication link to the first and second UEs.

In one example embodiment, the first portion of the uplink channel is a portion of uplink spectrum of the network.

### BRIEF DESCRIPTION OF THE DRAWINGS

Example embodiments will be more clearly understood from the following detailed description taken in conjunction with the accompanying drawings. FIGS. 1-3 represent non-limiting, example embodiments as described herein.

FIG. 1 illustrates an example embodiment of a network;

FIG. 2A illustrates an example embodiment of a UE with base station receiving functionality;

FIG. 2B illustrates an example embodiment of a base station; and

FIG. 3 illustrates a method of controlling communications between first and second UEs according to an example embodiment.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium. The tangible storage medium may be magnetic (e.g., a floppy disk or a hard drive) or optical (e.g., a compact disk read only memory, or “CD ROM”), and may be read only or random access. Example embodiments are not limited by these aspects of any given implementation.

As used herein, the term “user equipment” (UE) may be synonymous to a mobile user, mobile station, mobile terminal, user, subscriber, wireless terminal and/or remote station and may describe a remote user of wireless resources in a wireless communication network. The term “base station” may be understood as a one or more cell sites, enhanced Node-Bs (eNB), base stations, access points, and/or any terminus of radio frequency communication. Although current network architectures may consider a distinction between mobile/user devices and access points/cell sites, the example embodiments described hereafter may generally be applicable to architectures where that distinction is not so clear, such as ad hoc and/or mesh network architectures, for example.

The term “channel” may be understood as any combination of frequency band allocation, time allocation and code allocation.

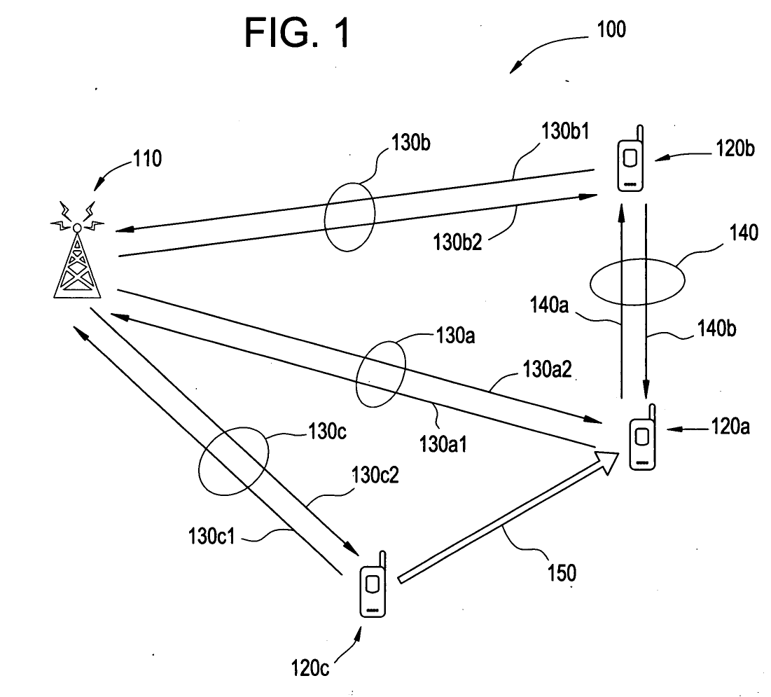

FIG. 1 illustrates an example embodiment of a network. As shown in FIG. 1, a network 100 includes a base station 110 and UEs 120a, 120b and 120c. The base station 110 may be an eNB, for example. The system 100 may be a time division duplexed (TDD) or frequency division duplexed (FDD) system.

Each UE 120a-120c communicates with the base station 110 via bi-directional communication links 130a, 130b, and 130c, respectively. Each of the bi-directional links includes an uplink 130a1, 130b1 and 130c1 and a downlink 130a2, 130b2, and 130c2.

The downlinks 130a2, 130b2, and 130c2 are channels from the base station 110 to the UEs 120a-120c, respectively. The base station 110 transmits on the downlinks 130a2, 130b2, and 130c2, and the UEs 120a-120c receive on the downlinks 130a2, 130b2, and 130c2, respectively.

The uplinks 130a1, 130b1 and 130c1 are channels from the UEs 120a-120c to the base station 110. The UEs 120a-120c transmit on the uplinks 130a1, 130b1 and 130c1, respectively, and the base station 110 receives on the uplinks 130a1, 130b1 and 130c1.

In frequency division duplex (FDD) the links 130a, 130b and 130c are separated in spectrum: one part of the spectrum is allocated to the uplink and another part of the spectrum is allocated to the downlink.

In time division duplex (TDD), the channels are separated in time, but occupy the same spectrum. Transmit and receive functions of the UE are alternated in different assigned time slots. In an FDD configuration, the UEs 120a-120c can transmit and receive simultaneously. In half-duplex mode the each UE 120a-120c either receives or transmits, having some radio modules of combined functionality. While some example embodiments have been described with reference to FDD and/or TDD, it should be understood that example embodiments should not be limited thereto and any other known method such as code division or orthogonal frequency-division multiplexing (OFDM), may be used.

In various example embodiments, UEs may include base station receiving and/or transmitting functions. The base station receiving function is the ability to receive data that has been transmitted on the uplink channel by a UE. The Base Station transmitting function is the ability to transmit data over the downlink channel in a manner that can be decoded by the UE.

In the time division duplexed (TDD) mode, a UE emulates base station functions by changing times of transmission and reception to some negotiated subset of the base station transmission and reception intervals. The negotiation here is between the base station and the UE intending to emulate base station operation. The base station mutes or powers down its transmitter during the time intervals that it assigns to the base station emulating-UE. The base station does not schedule transmissions by UEs attached to it, during these negotiated quiet periods. On the uplink, a UE transmitting to the base station can swap any transmissions destined for the base station emulating-UE.

In a frequency division duplexed (FDD) mode, the transmit and receive frequencies for the UE are switched for base station emulation.

Therefore, the UE contains an additional transmitting and receiving chain to permit such operation.

In the example embodiment shown in FIG. 1, the UEs 120a and 120b include the base station receiving functions and the UE 120c does not include base station functionality. Thus, the UEs 120a and 120b may receive communications across a combination of uplink channels and downlink channels of the network.

### Direct Communication Between UE 120a and UE 120b

Since the UEs 120a and 120b include base station receiving functionality, neither of the communicating UEs 120a and 120b emulates a base station transmitter. Each of the communicating UEs 120a and 120b emulates a base station receiver (e.g., receives on an uplink channel) in order to receive data from a UE peer. The base station 110 decides the uplink channel on which to receive by controlling the UEs 120a-120c to transmit on the designated uplink channels 130a1, 130b1, and 130c1, respectively.

The UEs 120a and 120b do not transmit while they are listening. Because neither of the UEs 120a and 120b transmits on the respective downlink channel 130a2 and 130b2, communication between the UEs 120a and 120b exists without emulating a base station transmitter.

Each of the UEs 120a and 120b may perform a discovery method to discover UEs within a communication range. Alternatively, the base station 110 may initiate a discovery method to determine which UEs are within a communication range. The discovery process may be any known method of discovering peers. If one of the UEs 120a and 120b discovers that the other UE is within the communication range, the one of the UEs 120a and 120b may request direct communication.

In FIG. 1, each of the UEs 120a-120c is considered to be within a communication range of each UE 120a-120c.

Because the UEs 120a and 120b are within a communication range, at least one of the UEs 120a and 120b transmits a request for direct communication to the base station 110 through the respective link 130a and 130b. In response to the request, the base station 110 initializes a direct communication link 140 by transmitting control information to the UEs 120a and 120b over a control path. The control path for the direct communication link 140 includes the bi-directional communication link 130a and the bi-directional communication link 130b.

Because the base station 110 controls the direct communication link 140, no user data is required to be transmitted across the communication links 130a and 130b. User data may be transmitted over the direct communication link 140.

The control path may be used by the base station 110 to discover proximate neighbors of each UE, assign the communication schedule and transmission parameters. The base station 110 can seamlessly disconnect the direct communication link 140 and replace it with a bearer-path (e.g., links 130a, 130b and 130c) passing through the base station 110 if overall system performance is degraded by the direct communication link 140.

The control information includes the transmission parameters for the direct communication link 140. The transmission parameters may also be referred to as a transmission channel configuration and may identify one or more of power level, data rate of transmission, coding and modulation format, code space, bandwidth and time slot allocation, duration of grant for direct communication, and other transmission parameters, for example.

More specifically, the direct communication link 140 includes links 140a and 140b. The UE 120a transmits information to the UE 120b over the link 140a and the UE 120b transmits information to the UE 120a over the link 140b. Once the direct communication link 140 is established by the base station 110, a portion of the uplink 130a1 is allocated to the link 140a. Thus, the UE 120a transmits over the link 140a using the same channel configuration (e.g., same frequency, code, transmission slot) as the uplink 130a1, except at a lower transmit power sufficient to reach the UE 120b. Consequently, the transmission channel configuration may be controlled from the base station 110 using any known method to control the uplinks 130a1, 130b1 and 130c1. A portion of the uplink 130b1 is allocated to the link 140b, by the base station 110, in the same manner as the portion of the uplink 130a1 is allocated to the link 140a.

The base station 110 determines the allocation of all or part of the uplink channels 130a1, 130b1, and 130c1 among the UEs 120a-120c in the system 100 based on a resource management function at the base station 110. Moreover, the base station 110 may determine the designated listening slots for the UEs 120a and 120b. Any known resource management function may be used. The known resource management function is implementation specific and is based on resources of the network while limiting the interference caused by transmissions by the UEs.

Based on the transmission parameters, each UE 120a and 120b transmits on the direct communication link 140 according to the transmission channel configuration of the direct communication link 140. The receiving UE in the direct communication link 140 listens on the uplink channel using the uplink transmit configuration associated with which the receiving UE expects to receive transmissions from the transmitting UE in the direction communication link 140. For example, the UE 120b listens on the link 140a based on the configuration of the uplink 130a1.

In one example embodiment, the base station 110 transmits a same set of transmission parameters assigned for the UEs 120a and 120b for the direct communication link 140 to the UEs 120a and 120b. In other words, the base station 110 transmits the transmission parameter for the UE 120b to the UE 120a and vice versa. Since each UE 120a and 120b receives the same set of transmission parameters, each UE 120a and 120b recognizes when and how the other UE is transmitting. Consequently, the UEs 120a and 120b may recognize the designated uplink channel to listen for transmissions across the direct communications link 140.

Alternatively, the base station 110 transmits reception parameters to the UEs 120a and 120b for the direct communication link 140, in addition to the transmission parameters, as part of the control information. For example, the reception parameters indicate which channel the UEs 120a and 120b are to listen on the direct communication link 140.

Once the UEs 120a and 120b receive the transmission parameters and, if applicable, the reception parameters, the UEs 120a and 120b may directly communicate across the direct communication link 140. For example, the direct communications link 140 may be full duplex in time if the UEs 120a and 120b include interference cancelling, which allows the UEs 120a and 120b to transmit and receive on the same frequency band at the same.

Since the UEs 120a and 120b are equipped with only base station receiving function, the equipment complexity is lower compared to UEs equipped with base station transmitting and receiving functions.

Furthermore, the UE 120c, which is in the vicinity of the peering UEs 120a and 120b can continue to communicate with the base station 110 since additional transmission occurs on the downlink from the base station 110.

### Direct Communication Between UE 120a and UE 120c

The direct communication between the UE 120a and the UE 120c is substantially similar to the direct communication between the UE 120a and the UE 120b. Therefore, only the differences will be described, for the sake of brevity.

In FIG. 1, the UE 120a includes base station receiving functions and the UE 120c does not include base station functionality. The base station 110 initializes a direct communication link by transmitting control information to the UEs 120a and 120c over a control path. The direct communication link between the UE 120a and the UE 120c includes a forward link, which includes the links 130a1 and 130c2, and a reverse link 150.

The control path for the direct communication link 130 includes the bi-directional communication link 130a and the bi-directional communication link 130c.

Because the UE 120c does not have the base station receiving function, the base station 110 transmits transmission parameters to the UE 120a indicating that the reverse link of the communications link from the UE 120a to the UE 120c should go through the base station 110 before reaching the UE 120c, and will include the links 130a1 and 130c2. The reverse link of the communication link from the UE 120c to the UE 120a will follow direct communications link 150, instead of following the conventional path 130c1 and 130a2.

In one example embodiment, the base station transmits a same set of transmission parameters assigned for the UEs 120a and 120c for the direct communication link to the UEs 120a. Since the UE 120a receives the set of transmission parameters, assigned for each UE 120a and 120c, the UE 120a recognizes when and with what characteristics the other UE 120c is transmitting. Consequently, the UE 120a may recognize the designated slots, frequency, code, and combination of the above allocated for the uplink transmission channel of the UE 120c to listen for transmissions across the direct communications link 150. The base station 110 conventionally sends a set of transmission and reception parameters to the UE 120c over the forward link 130c2, which will describe configuration of the transmission channel 150 and the receiving channel 130c2.

Alternatively, the base station transmits reception parameters to the UEs 120a and 120c for the direct communication link, in addition to the transmission parameters, as part of the control information.

For example, the base station 110 sends the reception parameters to the UE 120a over the link 130a2 of the control path indicating that the reverse link 150 (communications from the UE 120c) will be initiated by the UE 120c as the forward link, and can be received directly by the UE 120a.

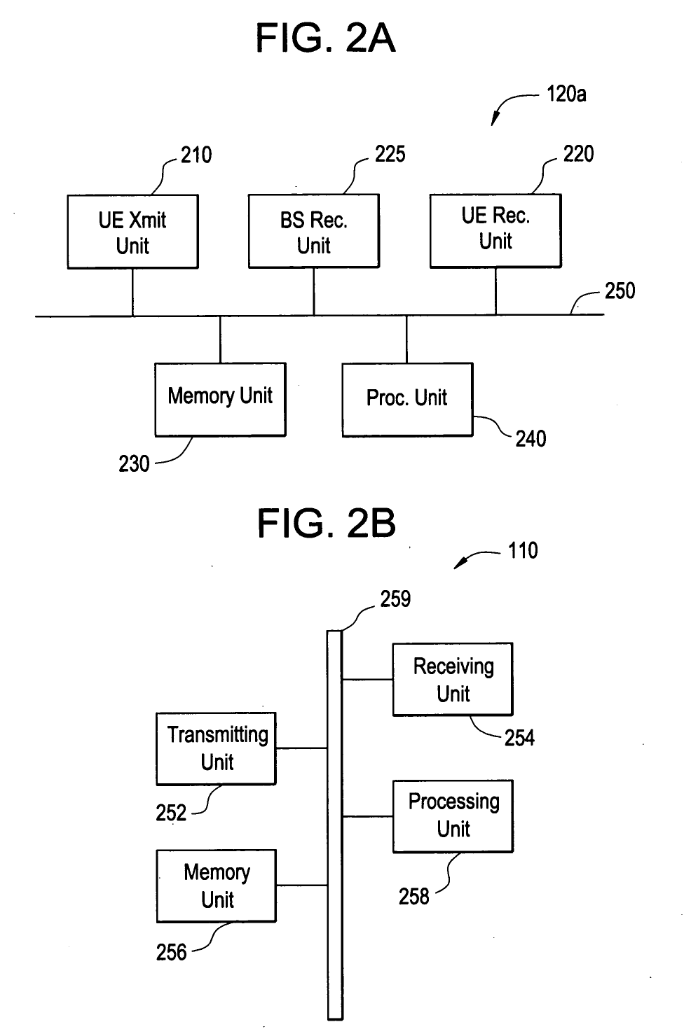

FIG. 2A illustrates an example embodiment of the UE 120a with base station receiving functionality. While only the UE 120a is shown, it should be understood that the UE 120b may have the same structure. It should be also understood that the UE 120a may include features not shown in FIG. 2A and should not be limited to those features that are shown.

The UE 120a, shown in FIG. 2A, is configured to receive data from a peer UE (e.g., the UE 120b) over an uplink channel of a network. The UE 120a is configured to receive control information for reception over a bi-directional link between the first UE and a base station. The UE 120a is configured to listen in designated slots of an uplink of the network. The UE 120a is configured to receive transmission parameters from a base station and is configured to determine reception parameters based on the transmission parameters. The UE 120a is configured to directly communicate with the peer UE in a half-time-duplex mode. The UE 120a is configured to directly communicate with the peer UE in a full-time duplex mode.

The UE 120a may include, for example, a transmitting unit 210, a UE receiving unit 220, a base station receiving unit 225, a memory unit 230, a processing unit 240, and a data bus 250.

The transmitting unit 210, UE receiving unit 220, base station receiving unit 225, memory unit 230, and processing unit 240 may send data to and/or receive data from one another using the data bus 250. The transmitting unit 210 is a device that includes hardware and any necessary software for transmitting wireless signals on the uplink (reverse link) including, for example, data signals, control signals, and signal strength/quality information via one or more wireless connections to other wireless devices (e.g., base stations).

The UE receiving unit 220 is a device that includes hardware and any necessary software for receiving wireless signals on the downlink (forward link) channel including, for example, data signals, control signals, and signal strength/quality information via one or more wireless connections from other wireless devices (e.g., base stations). The UE receiving unit 220 receives control information for reception over the bi-directional link 130a between the UE 120a and the base station 110. The UE 120a listens in designated slots of an uplink (reverse link) of the network.

The base station receiving unit 225 is implemented as a receiver chain including a low noise amplifier, mixer, filter, and baseband processor configured to receive signals transmitted on an uplink channel.

The memory unit 230 may be any storage medium capable of storing data including magnetic storage, flash storage, etc.

The processing unit 240 may be any device capable of processing data including, for example, a microprocessor configured to carry out specific operations based on input data, or capable of executing instructions included in computer readable code. The processing unit 240 may determine reception parameters based on the transmission parameters.

FIG. 2B illustrates an example embodiment of the base station 110. It should be also understood that the base station 110 may include features not shown in FIG. 2B and should not be limited to those features that are shown.

Referring to FIG. 2B, the base station 110 may include, for example, a data bus 259, a transmitting unit 252, a receiving unit 254, a memory unit 256, and a processing unit 258.

The transmitting unit 252, receiving unit 254, memory unit 256, and processing unit 258 may send data to and/or receive data from one another using the data bus 259. The transmitting unit 252 is a device that includes hardware and any necessary software for transmitting wireless signals including, for example, data signals, control signals, and signal strength/quality information via one or more wireless connections to other network elements in the wireless communications network 100. For example, the transmitting unit 252 transmits the transmission parameters for the direct communication links 140 and 150 to the UEs 120a-120c, respectively. If applicable, the transmitting unit 252 also transmits the reception parameters for the direct communication links 140 and 150.

The receiving unit 254 is a device that includes hardware and any necessary software for receiving wireless signals including, for example, data signals, control signals, and signal strength/quality information via one or more wireless connections to other network elements in the network 100.

The memory unit 256 may be any device capable of storing data including magnetic storage, flash storage, etc.

The processing unit 258 may be any device capable of processing data including, for example, a microprocessor configured to carry out specific operations based on input data, or capable of executing instructions included in computer readable code.

For example, the processing unit 258 is capable of determining when UEs are within a communication range. The processing unit 258 is also configured to control the control paths and the direct communication links 140 and 150. More specifically, the processing unit 258 determines the transmission parameters and, if applicable, the reception parameters. Consequently, the processing unit 258 allocates at least a first portion of an uplink channel of a network to a direct communication link.

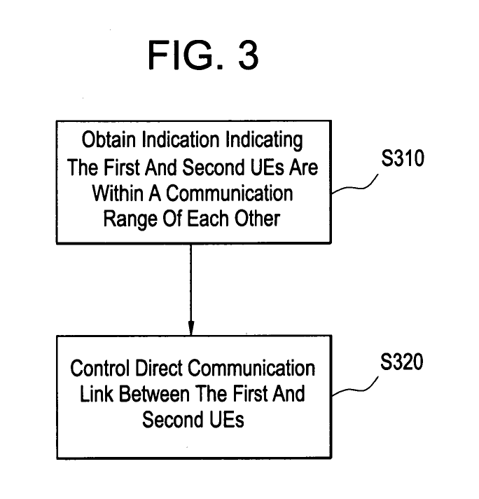

FIG. 3 illustrates a method of controlling communications between first and second UEs. The method shown in FIG. 3 may be performed by the base station 110 shown in FIG. 1. In the method of FIG. 3, the first UE is enhanced with a base station receiving function (e.g., the UE 120a).

As shown, at 5310, the base station obtains an indication. The indication indicates if the first and second UEs are within a communication range of each other. In one example embodiment, the first UE may perform a discovery method. Once the first UE discovers a UE (e.g., the second UE) is within a communication range, the first UE may transmit the indication to the base station. The indication also includes a request for direct communication with the second UE. If the second UE is enhanced with the base station receiving function (e.g., receive communications on the uplink channel), it should be understood that the second UE may also perform the discovery method.

In another example embodiment, the base station may perform the discovery method and determine that the first and second UEs are within a communication range of each other. If the first and second UEs are within the communication range, the base station informs the first and second UEs that they are within the communication of each other. In response, at least one of the first and second UEs may request direct communication between the first and second UEs.

Any known discovery method can be used such as in an ad-hoc mode of Wi-Fi, paring mode of Bluetooth systems or commercial wireless systems where a base station mediates communication between two UEs. Moreover, it should be understood that example embodiments should not be limited to the discovery methods explicitly recited herein.

Once the base station receives the indication, the base station controls a direct communication link between the first and second UEs, at 5320.

If the base station recognizes that the second UE does not include a base station receiving function, it may assist in establishing a direct transmission link from the second UE to the first UE and the conventional communications link from the first UE through the Base Station to the second UE.

The base station transmits control information over a control path. The control path includes a first bi-directional link between the base station and the first UE and a second bi-directional link between the base station and the second UE. The control information includes the transmission parameters.

Moreover, when the second UE is not enhanced with the base station receiving function, the base station transmits the transmission parameters to the first UE indicating that a forward link of the direction communications link from the first UE to the second UE should to reach the base station before reaching the second UE.

In one example embodiment, the base station transmits a same set of transmission parameters assigned for the first and second UEs for the direct communication link to the first and second UEs. Since each UE receives the same set of transmission parameters, each UE recognizes when the other UE is transmitting. Consequently, the first and second UEs may recognize the designated slots to listen for transmissions across the direct communications link for the first and second UEs. For example, since the first UE is configured to receive communications on the uplink channel, the first UE may listen for communications across the direct communication during the time slots the second UE is transmitting.

Alternatively, the base station transmits reception parameters to the first and second UE, in addition to the transmission parameters, as part of the control information.

For example, the base station sends the reception parameters to the first UE over the first bi-directional link of the control path indicating that a reverse link of the direct communications link (communications from the second UE) will be initiated by the second UE as the forward link, and can be received directly by the first UE.

The direct communications link is a data path that is either full or half-duplexed in time or frequency on the uplink. For example, the direct communications link may be full-duplexed in time if the first and second UEs include interference cancelling, which allows the first and second UEs to transmit and receive on the same frequency band at the same time.

The base station communicates the channel assignment parameters to the second UE in a conventional way.

As the result, the first UE receives the transmission from the second UE directly across a portion of the upstream channel, while second UE receives the communications from the first UE through the base station. In other words, the transmit power of the second UE is significantly reduced in order to only accommodate local direct mode reception by the first UE in close proximity, thus providing the gain.

As described, the methods and networks of example embodiments permit an operator of the network to control peer to peer communications.

In at least one example embodiment, user equipments (UEs) are augmented with a base station receive function. In other words, the UEs are configured to receive data on an uplink transmission frequency.

A direct communication link between UEs is supported by the uplink spectrum. A half-duplex mode is used when the UEs are not equipped with self-interference cancellation technology. A full-duplex mode can be used when UEs are capable of self-interference control.

A control path for the direct communication link is a pair of bi-directional links between a base station and each of the UEs in the direct-communication pair.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method of controlling communications between first and second user equipments (UEs) by a base station in a network, the method comprising:
obtaining an indication, the indication indicating if the first and second UEs are within a communication range of each other; and
controlling a direct communication link between the first and second UEs if the first and second UEs are within a communication range of each other, the controlling including,
allocating at least a first portion of an uplink channel of the network to the direct communication link.

2. The method of claim 1, wherein the controlling a direct communication link includes transmitting control information over a control path.

3. The method of claim 2, wherein the control path includes a bi-directional link between the base station and the first UE and a bi-directional link between the base station and the second UE.

4. The method of claim 1, wherein the controlling a direct communication link includes transmitting transmission parameters for the direct communication link to the first and second UEs.

5. The method of claim 4, wherein the transmitting transmission parameters includes transmitting a same set of transmission parameters assigned for the first and second UEs for the direct communication link to the first and second UEs.

6. The method of claim 4, wherein the controlling a direct communication link includes transmitting reception parameters for the direct communication link to the first and second UEs.

7. The method of claim 4, wherein the transmission parameters are based on the UE.

8. The method of claim 7, wherein the transmission parameters include a duplex mode, the duplex mode being a full-duplex or a half-duplex.

9. The method of claim 1, further comprising:
receiving data from the first UE; and
transmitting the data to the second UE,
wherein the second UE is configured to only receive data on a downlink.

10. The method of claim 1, further comprising:
transmitting information on a downlink to the first UE while the first UE monitors communications on the direct communication link.

11. The method of claim 1, wherein the controlling a direct communication link includes transmitting reception parameters for the direct communication link to the first and second UEs.

12. A first user equipment (UE) configured to receive data from a peer UE over an uplink channel of a network.

13. The first UE of claim 12, wherein the first UE is configured to receive control information for reception over a bi-directional link between the first UE and a base station.

14. The first UE of claim 12, wherein the first UE is configured to listen in designated slots of an uplink of the network.

15. The first UE of claim 12, wherein the first UE is configured to receive transmission parameters from a base station and is configured to determine reception parameters based on the transmission parameters.

16. A base station configured to determine if first and second equipments (UEs) are within a communication range of each other, control a direct communication link between the first and second UEs if the first and second UEs are within a communication range of each other and allocate at least a first portion of an uplink channel of a network to the direct communication link.

17. The base station of claim 16, wherein the base station is further configured to transmit transmission parameters for the direct communication link to the first and second UEs.

18. The base station of claim 17, wherein the base station is further configured to transmit a same set of transmission parameters assigned for the first and second UEs for the direct communication link to the first and second UEs.

19. The base station of claim 17, wherein the base station is further configured to transmit reception parameters for the direct communication link to the first and second UEs.

20. The base station of claim 16, wherein the base station is further configured to transmit reception parameters for the direct communication link to the first and second UEs.

21. The base station of claim 16, wherein the first portion of the uplink channel is a portion of uplink spectrum of the network.
